(19) United States
(12) Patent Application Publication
(10) Pub. No.: US 2010/0323138 A1
(43) Pub. Date: Dec. 23, 2010

(54) Electromagnetic Interference Suppression Flat Yarn, Electromagnetic Interference Suppression Article Using the Flat Yarn, and Method for Manufacturing the Flat Yarn and Article Using the Same

(75) Inventors: Takashi Yoshioka, Tokyo (JP); Hiroki Ohsugi, Ishikawa (JP)

Correspondence Address: CROCKETT & CROCKETT, P.C., 26020 ACERO, SUITE 200, MISSION VIEJO, CA, 92691, US

(73) Assignee: DIATEX Co., Ltd

(21) Appl. No.: 12/666,451

(22) PCT Filed: May 1, 2009
(86) PCT No.: PCT/JP2009/058561

§ 371 Date: Dec. 23, 2009

(30) Foreign Application Priority Data
May 2, 2008 (JP) 2008-120779

(51) Int. Cl. D02G 3/06; D02G 3/44; D04B 1/16; D06M 11/83; D06M 11/73; G21F 3/00

(52) U.S. Cl. 428/36.1; 428/394; 428/367; 428/379; 428/380; 428/383; 442/308; 428/222

(57) ABSTRACT

Object: To provide an EMI suppression flat yarn, an EMI suppression article using the flat yarn, and a method for manufacturing the flat yarn and article that exhibit excellent flexibility, do not become cracked or rigid even when attached to curved portions, wire harnesses, or electrical cables, and enable electronic devices to be lighter, flatter, shorter, and smaller.
Solution Means: An EMI suppression flat yarn including:
an EMI absorbing polymer resin layer (I) capable of absorbing EMI, wherein a value of return loss (S11) as measured according to IEC-62333 is −1 dB or less over an entire range of EMI frequencies of 300 MHz to 18 GHz, and a value of transmission loss (S21) as measured according to IEC-62333 is −1 dB or less over an entire range of EMI frequencies of 300 MHz to 18 GHz; and a polymer resin layer (II) on one surface of the EMI absorbing polymer resin layer (I); or
including a polymer resin layer (II) on one surface of the EMI absorbing polymer resin layer (I); and a polymer resin layer (III) on another surface of the EMI absorbing polymer resin layer (I);
the EMI suppression flat yarn being formed into a fabric, knit, or braid;
an EMI suppression article using the flat yarn; and
a method for manufacturing the EMI suppression flat yarn and article using the flat yarn.

### FIELD OF THE INVENTION

The present invention relates to an electromagnetic interference (EMI) suppression flat yarn, an EMI suppression article using the flat yarn, and a method for manufacturing the flat yarn and article using the flat yarn.

### BACKGROUND OF THE INVENTION

EMI has recently been a problem because of the rapid prevalence of electronic devices such as mobile phones, lowered anti-noise performance due to the integration and improved performance of the devices, and lowered shield property for EMI due to the increasing use of plastic casings for size and weight reductions of the devices.

Patent literature 1 discloses an EMI absorbing fiber that has higher EMI shield performance and can be woven with a loom in the same manner as general fabrics, by increasing the proportion of the area of a metal wire material and a conductive carbon fiber exposed on the surface as much as possible in an EMI shield fabric.

Patent literature 2 discloses an antibacterial EMI shield article comprising a substrate; a thin foil formed on the substrate; and a coating layer formed on the foil and having a coating material and antibacterial particles.

However, patent literature 1 uses a fabric obtained by weaving a metal wire material, and patent literature 2 uses a thin foil. For this reason, these articles have poor flexibility, and become cracked or rigid when attached to curved portions, wire harnesses, or electrical cables, thus preventing electronic devices from becoming lighter, flatter, shorter, and smaller.

Moreover, no prior art literatures disclose an EMI suppression flat yarn made of a polymer resin.
Patent Literature 1: Japanese Unexamined Patent Publication No. 2007-169804
Patent Literature 2: Japanese Unexamined Patent Publication No. 2000-183563

### DISCLOSURE OF THE INVENTION

### Problem to be Solved by the Invention

Accordingly, it is an object of the invention to provide an EMI suppression flat yarn, an EMI suppression article using the flat yarn, and a method for manufacturing the flat yarn and article using the flat yarn that exhibit excellent flexibility, do not become cracked or rigid even when attached to curved portions, wire harnesses, or electrical cables, and enable electronic devices to be lighter, flatter, shorter, and smaller.

Other objects of the invention will become apparent from the following description.

### Means for Solving the Problem

The above-mentioned object is solved by each of the following inventions.

The invention according to claim 1 is an EMI suppression flat yarn including an EMI absorbing polymer resin layer (I) capable of absorbing EMI, wherein a value of return loss (S11) as measured according to IEC-62333 is −1 dB or less over an entire range of EMI frequencies of 300 MHz to 18 GHz, and a value of transmission loss (S21) as measured according to IEC-62333 is −1 dB or less over an entire range of EMI frequencies of 300 MHz to 18 GHz; and a polymer resin layer (II) on one surface of the EMI absorbing polymer resin layer (I); or

including a polymer resin layer (II) on one surface of the EMI absorbing polymer resin layer (I); and a polymer resin layer (III) on another surface of the EMI absorbing polymer resin layer (I).

The invention according to claim 2 is the EMI suppression flat yarn as defined in claim 1, wherein the EMI absorbing polymer resin layer (I) includes a polyurethane polymer resin; and a metal powder capable of absorbing EMI and/or a carbon black powder.

The invention according to claim 3 is the EMI suppression flat yarn as defined in claim 1 or 2, wherein the polymer resin layer (II) or polymer resin layer (III) is at least one polymer resin layer selected from a polyester resin layer, a polyetherimide resin layer, a polyimide resin layer, a polyphenylene sulfide resin layer, and a polyurethane resin layer.

The invention according to claim 4 is an EMI suppression article formed into any of a fabric, tube, knit, or braid, using as a material the EMI suppression flat yarn as defined in any of claims 1 to 3.

The invention according to claim 5 is a method for manufacturing an EMI suppression flat yarn, including mixing a polyurethane resin and a metal powder and/or a carbon black powder with stirring to prepare a solution of an EMI absorbing polymer resin composition; applying the solution of the EMI absorbing polymer resin composition to a polymer resin layer (II), and drying the solution, to form an EMI absorbing polymer resin layer (I), thereby manufacturing a two-layered EMI suppression film; and cutting the laminated film into a slit.

The invention according to claim 6 is the method as defined in claim 5, wherein another polymer resin layer (III) is formed on a surface opposite the surface of the EMI absorbing polymer resin layer (I) having the polymer resin layer (II) thereon, of the laminated film of the EMI absorbing polymer resin layer (I) and polymer resin layer (II), thereby manufacturing a three-layered EMI suppression film.

The invention according to claim 7 is the method as defined in claim 6, wherein the polymer resin layer (II) or polymer resin layer (III) is at least one polymer resin layer selected from a polyester resin layer, a polyetherimide resin layer, a polyimide resin layer, a polyphenylene sulfide resin layer, and a polyurethane resin layer.

The invention according to claim 8 is a method for manufacturing an EMI suppression flat yarn, including mixing a polyurethane resin solution in which a polyurethane resin is dissolved in a solvent and a metal powder and/or a carbon black powder with stirring to prepare a solution of an EMI absorbing polymer resin composition; applying the solution of the EMI absorbing polymer resin composition to a release paper, and drying the solution, to form an EMI absorbing polymer resin layer (I); forming a polymer resin layer (II) on the EMI absorbing polymer resin layer (I); peeling the release paper to manufacture a laminated film; and cutting the laminated film into a slit.

The invention according to claim 9 is the method as defined in claim 8, wherein the polymer resin layer (II) is at least one polymer resin layer selected from a polyester resin layer, a polyetherimide resin layer, a polyimide resin layer, a polyphenylene sulfide resin layer, and a polyurethane resin layer.

The invention according to claim 10 is a method for manufacturing the EMI suppression flat yarn as defined in any of claims 5 to 9, the flat yarn including an EMI absorbing polymer resin layer (I) capable of absorbing EMI, wherein a value of return loss (S11) as measured according to IEC-62333 is −1 dB or less over an entire range of EMI frequencies of 300 MHz to 18 GHz, and a value of transmission loss (S21) as measured according to IEC-62333 is −1 dB or less over an entire range of EMI frequencies of 300 MHz to 18 GHz.

### Effects on the Invention

The present invention provides an EMI suppression flat yarn, an EMI suppression article using the flat yarn, and a method for manufacturing the flat yarn and article using the flat yarn that exhibit excellent flexibility, do not become cracked or rigid even when attached to curved portions, wire harnesses, or electrical cables, and enable electronic devices to be lighter, flatter, shorter, and smaller.

### BRIEF DESCRIPTION OF THE DRAWINGS

FIG. 1 is a perspective view of the cutaway of a principal portion showing one example of the EMI suppression article of the invention;

FIG. 2 is a diagram showing another example of the EMI suppression article of the invention;

FIG. 3 is a diagram showing still another example of the EMI suppression article of the invention;

FIG. 4 is a diagram showing still another example of the EMI suppression article of the invention; and

FIG. 5 is a diagram showing still another example of the EMI suppression article of the invention.

### EXPLANATION OF REFERENCE NUMERALS

1, 6: Cable Core

2, 5: Insulating Polymer resin Layer

3, 3A, 3B: Tubular Material

4: Protective Layer

### BEST MODE FOR CARRYING OUT THE INVENTION

Embodiments of the invention are described below.

The EMI suppression flat yarn of the invention is used as a fabric, tube, knit, braid, or the like, and includes an EMI absorbing polymer resin layer (I) capable of absorbing EMI, wherein a value of return loss (S11) as measured according to IEC-62333 is −1 dB or less over an entire range of EMI frequencies of 300 MHz to 18 GHz, and a value of transmission loss (S21) as measured according to IEC-62333 is −1 dB or less over an entire range of EMI frequencies of 300 MHz to 18 GHz; and a polymer resin layer (II) on one surface of the EMI absorbing polymer resin layer (I); or includes a polymer resin layer (II) on one surface of the EMI absorbing polymer resin layer (I); and a polymer resin layer (III) on another surface of the EMI absorbing polymer resin layer (I).

More specifically, the polymer resin layer (II) is laminated on one surface of the EMI absorbing polymer resin layer (I) having the above-described characteristics; or the polymer resin layer (II) is laminated on one surface, and the polymer resin layer (III) is laminated on another surface, of the EMI absorbing polymer resin layer (I). This results in excellent manufacturability and strength of the flat yarn, as well as excellent flexibility of a knit and like articles manufactured using the flat yarn. Consequently, the EMI suppression flat yarn of the invention do not become cracked or rigid even when attached to curved portions, wire harnesses, or electrical cables, and enable electronic devices to be lighter, flatter, shorter, and smaller.

The transmission loss (S21) and return loss (S11) of the EMI absorbing polymer resin layer (I) defined in the invention can be equally achieved when the EMI suppression flat yarn of the invention is formed into a fabric or knit. Flat yarns using the EMI absorbing polymer resin layer (I), in which both the transmission loss (S21) and return loss (S11) exhibit predetermined characteristics, have been heretofore unknown; therefore, such a flat yarn is provided by the present inventors as a novel invention.

In the invention, preferable ranges of the transmission loss (S21) and return loss (S11) are as shown in Table 1 below.

TABLE 1

| | | | Preferable | More Preferable | Still More | Particularly |
|---|---|---|---|---|---|---|
| | | | Range | Range | Preferable Range | Preferable Range |
| S21 | 300 | MHz or more and less than 1.0 GHz | -1.1 to -80 dB | -1.15 to -50 dB | -1.2 to -10 dB | -1.3 to -5 dB |
| | 1.0 | GHz or more and less than 1.5 GHz | -2 to -80 dB | -2.3 to -50 dB | -2.6 to -30 dB | -3 to -10 dB |
| | 1.5 | GHz or more and less than 5 GHz | -3 to -80 dB | -3.5 to -50 dB | -4 to -30 dB | -5 to -20 dB |
| | 5 | GHz or more and less than 10 GHz | -3 to -80 dB | -5 to -50 dB | -8 to -40 dB | -10 to -30 dB |
| S11 | 300 | MHz or more and less than 1.0 GHz | -3 to -30 dB | -4 to -25 dB | -5 to -20 dB | -7 to -10 dB |
| | 1.0 | GHz or more and less than 1.5 GHz | -3 to -30 dB | -4 to -25 dB | -5 to -20 dB | -7 to -15 dB |
| | 1.5 | GHz or more and less than 5 GHz | -3 to -30 dB | -3.3 to -25 dB | -3.7 to -20 dB | -4 to -10 dB |
| | 5 | GHz or more and less than 10 GHz | -3 to -30 dB | -3.3 to -25 dB | -3.7 to -20 dB | -4 to -10 dB |

For reference purposes, examples of EMI generating portions and their EMI frequencies are as follows: One-segment broadcasting TV: 470 to 770 MHz; and mobile phones: 810 to 940 MHz and 1429 to 1501 MHz. EMI in these ranges is absorbed by using the EMI suppression flat yarn of the invention.

Examples of polymer resins used as the EMI absorbing resin layer (I) include a polyurethane resin, a polyester resin, a polyvinyl butyral resin, an acrylic resin, an epoxy resin, a vinyl chloride resin, a polyacetal resin, a vinyl acetate resin, and a fluorocarbon polymers. Among these, a polyurethane resin is preferred because it imparts flexibility and strength to the polymer resin layer.

The EMI absorbing polymer resin layer (I) contains a metal powder capable of absorbing EMI and/or a conductive material powder.

Examples of metals capable of absorbing EMI include metals selected from aluminum, copper, nickel, silver, zinc, tin, chromium, gold, platinum, iron, cobalt, zirconium, molybdenum, and titanium; alloys of two or more of these metals; halides, complexes, oxides, and sulfides of these metals or alloys.

Among these, magnetite (Fe₃O₄) as a magnetic powder, an alloy such as Fe—Si—Al or Fe₃Si, or the like is preferred.

The metal powder capable of absorbing EMI is preferably ground with a grinder, and subsequently classified to remove large coarse particles.

The average particle size of the powder after classification is preferably 0.1 to 200 μm, more preferably 0.15 to 150 μm, and particularly preferably 0.2 to 100 μm.

In the invention, classification is conducted by selecting the mesh size of a sieve, and setting the particle size distribution. The mesh size of the sieve is preferably 250 μm, more preferably 200 μm, and particularly preferably 125 μm.

If the metal powder used is not classified to remove large coarse particles, the EMI absorbing polymer resin layer (I) may develop some projections from the surface thereof, causing the formation of pinholes or bubbles inside the polymer resin layer, possibly resulting in a breakage during the manufacture of the flat yarn.

The metal powder may have any shape, such as a spherical, flat, cylindrical, needle-like, indefinite, or a like shape.

Carbon black is mentioned as an example of the conductive material powder. The average particle size of the carbon black is preferably 10 to 60 nm. The average particle size is measured by the arithmetical average method using an electron microscope.

The amount of the metal powder capable of absorbing EMI is preferably 0 to 900 parts by weight, and the amount of the carbon black is preferably 10 to 500 parts by weight, based on 100 parts by weight of the polymer resin.

The EMI absorbing polymer resin layer (I) preferably further contains a flame retardant (for example, melamine cladding ammonium polyphosphate), and may additionally contain various additives such as organic pigments, inorganic pigments, light stabilizers, and the like, as needed.

The thickness of the EMI absorbing polymer resin layer (I) is preferably 5 to 500 μm, and more preferably 10 to 100 μm.

The invention encompasses an embodiment in which the polymer resin layer (II) is laminated on one surface of the EMI absorbing polymer resin layer (I); and an embodiment in which the polymer resin layer (II) is laminated on one surface of the EMI absorbing polymer resin layer (I), and the polymer resin layer (III) is formed on another surface thereof. An intermediate layer may be optionally provided between the EMI absorbing polymer resin layer (I) and the polymer resin layer (II) or polymer resin layer (III). A polymer resin layer may be further provided on an outer surface of the polymer resin layer (II) or polymer resin layer (III).

Examples of polymer resins used as the polymer resin layer (II) and polymer resin layer (III) include, in addition to those used as the EMI absorbing polymer resin layer (I), polyester resins, polyetherimide resins, polyimide resins, and polyphenylene sulfide resins. Particularly preferable is one polymer resin selected from a polyester resin layer, a polyetherimide resin layer, a polyimide resin layer, a polyphenylene sulfide resin layer, and a polyurethane resin layer.

The polymer resin layer (II) or polymer resin layer (III) preferably further contains a flame retardant (for example, melamine cladding ammonium polyphosphate), and may additionally contain various additives such as organic pigments, inorganic pigments, light stabilizers, and the like, as needed.

The polymer resin layer (II) or polymer resin layer (III) can be formed by using a film product as is, or by applying a film product.

The polymer resin used to form the polymer resin layer (II) or (III) by application preferably has a weight average molecular weight of 50,000 to 1,000,000. If the weight average molecular weight is below this range, physical properties for practical purposes cannot be obtained; whereas if it exceeds this range, the melting viscosity or the viscosity of the polymer resin when dissolved in a solvent will become too high, resulting in poor film processability during the formation of the polymer resin layer.

The polymer resin used as the polymer resin layer (II) or polymer resin layer (III) preferably has a glass transition point of −20° C. or more, and more preferably −10° C. or more. If the glass transition point is below the lower limit, blocking of the resulting flat yarn may occur.

When both of the polymer resin layer (II) and polymer resin layer (III) are provided, the same polymer resin may be used, or different polymer resins may be used.

Accordingly, examples of layer structures of the EMI suppression flat yarn of the invention include a two-layered structure of the EMI absorbing polymer resin layer (I)/polymer resin layer (II); and a three-layered structure of the polymer resin layer (III)/EMI absorbing polymer resin layer (I)/polymer resin layer (II).

Next, one example of the method for manufacturing the EMI suppression flat yarn of the invention used as a fabric, tube, knit, braid, or the like, is described.

A polymer resin used as the EMI absorbing polymer resin layer (I), e.g., a polyurethane polymer resin, is dissolved in a solvent to prepare a polymer resin solution. As the solvent, N,N-dimethylformamide (DMF), toluene, methyl ethyl ketone (MEK), or the like can be used alone, or a mixture thereof can be preferably used.

The polymer resin solution is subsequently mixed with a metal powder and/or a carbon black powder with stirring, to prepare a solution of an EMI absorbing polymer resin composition. The means for mixing these components with stirring is not particularly limited.

In the invention, both of a metal powder and carbon black powder may be used, or either one of them may be used. Prior to use, the metal powder is preferably ground with a grinder, and subsequently classified to remove large coarse particles.

The solution of the EMI absorbing polymer resin composition is subsequently applied to a polymer resin layer (II) by using a doctor blade, for instance, and dried to form an EMI absorbing polymer resin layer (I), thereby manufacturing a two-layered film.

The drying temperature is preferably 50 to 250° C., and the drying time is preferably 5 seconds to 30 minutes.

Further, a polymer resin layer (III) is formed on the surface opposite the surface of the EMI absorbing polymer resin layer (I) having the polymer resin layer (II) thereon, thereby manufacturing a three-layered EMI suppression film.

Another preferable method for manufacturing a laminated film, which is different from the method described above, is as follows.

A polymer resin solution in which a polyurethane resin is dissolved in a solvent is mixed with a metal powder and/or a carbon black powder with stirring, to prepare a solution of an EMI absorbing polymer resin composition. The solution of the EMI absorbing polymer resin composition is applied to a release paper and dried to form an EMI absorbing polymer resin layer (I). A polymer resin layer (II) is then formed on the EMI absorbing polymer resin layer (I). The release paper is subsequently peeled to manufacture a laminated film.

Next, the thus-manufactured laminated film is cut into a slit. The slitting means is not particularly limited; a general slitter (cutter) can be used.

After slitting, the EMI suppression flat yarn of the invention can be obtained.

The size of the EMI suppression flat yarn of the invention is by no means limited, and can be set as desired according to the purpose. The EMI suppression flat yarn typically has a size of 50 to 10,000 dtex, preferably 100 to 5,000 dtex, and more preferably 150 to 3,000 dtex.

The EMI suppression flat yarn of the invention preferably has a thickness of 5 to 1000 μm, and more preferably 10 to 500 μm.

The EMI suppression flat yarn of the invention preferably has a width of 0.3 to 100 mm, more preferably 0.4 to 80 mm, still more preferably 0.45 to 50 mm, and particularly preferably 0.5 to 5 mm.

The EMI suppression flat yarn of the invention preferably has a strength of 0.005 to 100 N/mm, and more preferably 0.01 to 50 N/mm. If the strength is less than 0.005 N/mm, the flat yarn will be impractical because of the poor binding strength; whereas a strength exceeding 100 N/mm is too high, so that the resulting sheet will be too hard and not flexible.

The EMI suppression flat yarn preferably has an elongation of 5 to 1000%, and more preferably 10 to 50%. If the elongation is less than 5%, the resulting cloth or sheet will have poor flexibility, conformability, and impact resistance. If the elongation exceeds 1000%, stretching will be too great, resulting in lowered mechanical stability.

In the invention, the above-described EMI suppression flat yarn can be used as is as an EMI suppression article, or can form a material for an EMI suppression fabric or braid, to yield an EMI suppression article as a final product.

In the method for manufacturing an EMI suppression fabric, the thus-obtained EMI suppression flat yarn is used as either one or both of the warp and weft to prepare a cloth-like fabric, using a loom.

Examples of weaving methods include plain weave including basket weave, warp rib weave, and weft rib weave; twill weave including steep twill weave, reclined twill weave, and pointed twill weave; satin weave including double satin weave, satin check weave, and granite weave; double cloth weave; and mock leno weave.

In the invention, a polyamide composition obtained by mixing a polyamide resin with a flame retardant can be extrusion laminated to the cloth-like fabric obtained by the above-described manufacturing method to provide an EMI suppression sheet.

In the method for manufacturing an EMI suppression knit, the EMI suppression flat yarn obtained by the above-described manufacturing method is knitted with a knitter to prepare a cloth-like knit.

Examples of knitting methods include warp knitting and weft knitting. Examples of weft knitting include plain stitch, rib stitch, and purl stitch; variations thereof include tuck stitch, float stitch, half cardigan stitch, lace stitch, and full cardigan stitch.

Examples of warp knitting include closed loop and open loop; variations thereof include milanese, tricot, mesh, and raschel.

In the invention, a polyamide composition obtained by mixing a polyamide resin with a flame retardant can be laminated in the form of a film to the knit obtained by the above-described manufacturing method to provide an EMI suppression sheet, according to the purpose.

Uses of the EMI suppression flat yarn of the invention are next described with reference to the drawings.

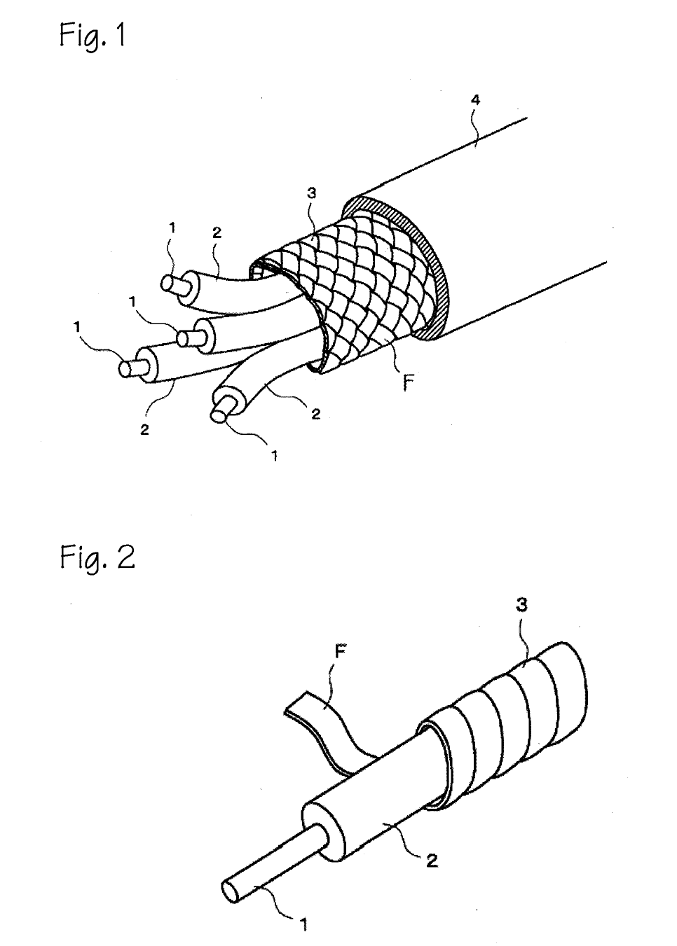

FIG. 1 shows an example in which a tubular material formed using an EMI suppression flat yarn F of the invention is used to cover the outer periphery of a cable. Reference numeral 1 denotes a cable core, reference numeral 2 denotes an insulating polymer resin layer, reference numeral 3 denotes a tubular material formed of the EMI suppression flat yarn of the invention, and reference numeral 4 denotes a protective layer.

The tubular material 3 may be formed by, for example, using an braid formed with a round braider. Moreover, as shown in FIG. 2, the tubular material 3 may be formed by spirally winding the EMI suppression flat yarn F of the invention around the outer periphery of a cable. Furthermore, the tubular material 3 can be formed by spirally winding an braid formed using a round braider around a cable, as shown in FIG. 2.

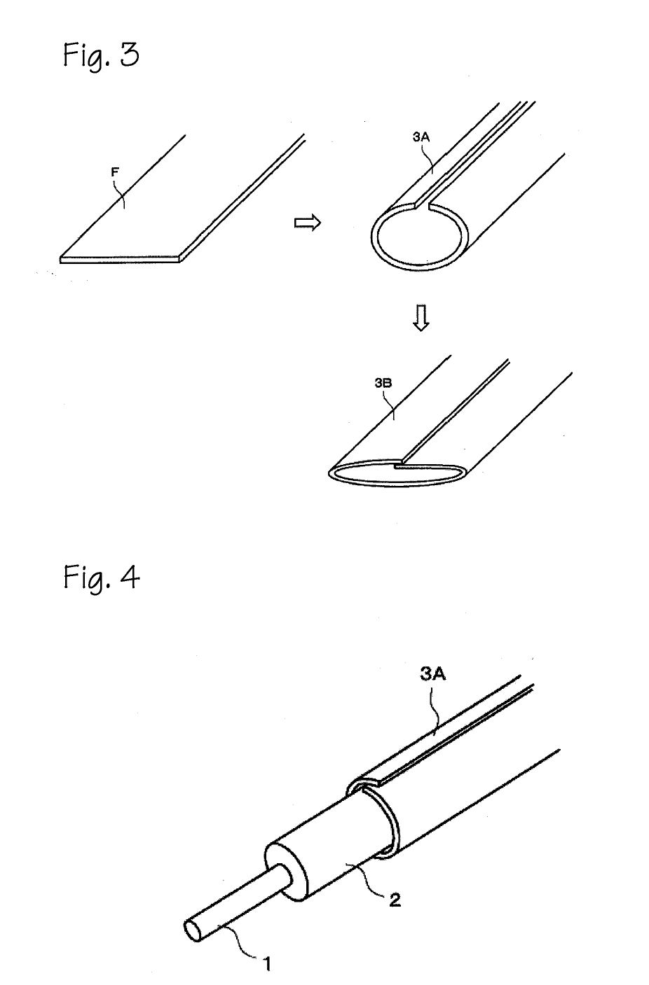

Furthermore, as shown in FIG. 3, the EMI suppression flat yarn F of the invention can be folded into a tubular shape in the longitudinal direction, and rolled into the form of rolled sushi to give a tubular material 3A. The tubular material obtained after being rolled into the form of rolled sushi may be subsequently flattened to give a tubular material 3B formed into the form of an envelope.

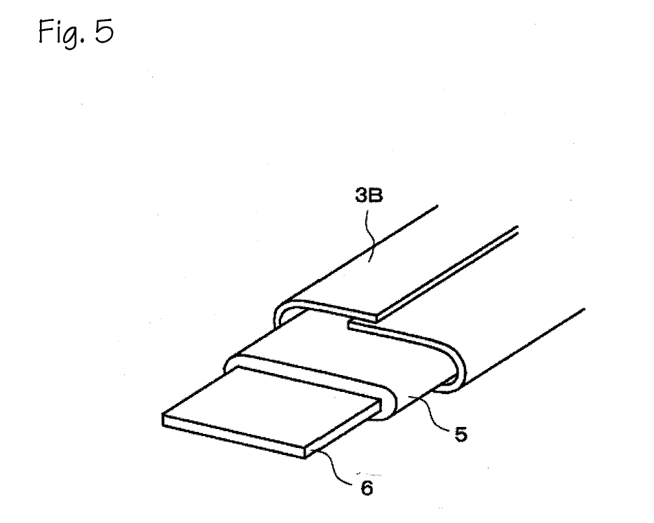

The tubular material 3A obtained by being rolled into the form of rolled sushi can be wound around the outer periphery a cable, as shown in FIG. 4. The tubular material 3B formed into the form of an envelope can be wound around the outer periphery of a flat cable, as shown in FIG. 5. Reference numeral 4 denotes a cable core of a flat cable, and reference numeral 5 denotes an insulating polymer resin layer.

The tubular material 3A obtained by being rolled into the form of rolled sushi and the tubular material 3B formed into the form of an envelope can also be used without being adhered.

### Examples

Examples of the invention are described below; however, the invention is not limited to these Examples.

### Example 1

Fe₃O₄ powder (magnetite powder) was used as a metal powder and ground with a grinder, after which the ground powder was classified to remove large coarse particle. The resulting powder had an average particle size of 5 μm.

300 Parts by weight of the magnetite powder after classification, 100 parts by weight of a carbon black powder as a conductive material, and 100 parts by weight of a polyurethane dissolved in 300 parts by weight of N,N-dimethylformamide (DMF), 30 parts by weight of toluene, and 170 parts by weight of methyl ethyl ketone (MEK) were mixed with stirring, thus giving a solution of an EMI absorbing polymer resin composition.

The resulting solution of the EMI absorbing polymer resin composition was applied to a release paper using a doctor blade, and dried at 140° C. for 3 minutes, thus giving an EMI absorbing polymer resin layer (I) with a thickness of 60 μm.

Further, 100 parts by weight of a polyurethane resin dissolved in 150 parts by weight of DMF and 100 parts by weight of toluene, 130 parts by weight of melamine cladding ammonium polyphosphate as a flame retardant, and 170 parts by weight of MEK as a solvent were mixed with stirring to give a polyurethane solution, and the polyurethane solution was similarly applied to the EMI absorbing polymer resin layer (I) using a doctor blade and dried, thus forming a polymer resin layer (II).

The release paper was subsequently peeled, thus giving a two-layered EMI suppression film with a thickness of 110 μm.

The resulting EMI suppression film was cut into a slit with a cutter to yield an EMI suppression flat yarn with a thickness of 110 μm and a width of 3 mm.

The resulting flat yarn was woven in a plain weave with a yarn count of 8 by 8 yarns per 25.4 mm, using a Sulzer loom, thus yielding a cloth-like material.

A polyamide composition obtained by mixing 90 parts by weight of a polyamide resin (Mitsubishi Engineering-Plastics Corporation; Nylon 6# 1020) with 10 parts by weight of a flame retardant (Mitsubishi Chemical; a melamine cyanurate flame retardant) was extrusion laminated to the obtained cloth-like material, thus giving an EMI suppression sheet.

The polyamide film had a thickness of 50 μm.

### Example 2

100 Parts by weight of a carbon black powder as a conductive material, and 100 parts by weight of a polyurethane resin dissolved in 300 parts by weight of DMF, 30 parts by weight of toluene, and 170 parts by weight of MEK, were mixed with stirring, thus giving a solution of an EMI absorbing polymer resin composition.

The resulting solution of the EMI absorbing polymer resin composition was applied to a 25 μm thick polyester (PET) film (Unitika; “S-25”), i.e., a polymer resin layer (II), using a doctor blade, and dried at 140° C. for 3 minutes, thus giving an EMI absorbing polymer resin layer (I) with a thickness of 50 μm.

Further, 100 parts by weight of a polyurethane resin dissolved in 150 parts by weight of DMF and 100 parts by weight of toluene, 130 parts by weight of melamine cladding ammonium polyphosphate as a flame retardant, and 170 parts by weight of MEK as a solvent were mixed with stirring to give a polyurethane solution, and the polyurethane solution was similarly applied to a surface of the EMI absorbing polymer resin layer (I) (opposite the surface having the polymer resin layer (II) thereon), using a doctor blade, and dried to form a polymer resin layer (III), thus yielding a three-layered EMI suppression film with a thickness of 130 μm.

The resulting film was cut into a slit with a cutter to yield an EMI suppression flat yarn with a thickness of 130 μm and a width of 3 mm.

The resulting flat yarn was woven in a plain weave with a yarn count of 8 by 8 yarns per 25.4 mm, using a Sulzer loom, thus yielding a cloth-like material.

The same polyamide composition as that of Example 1 was extrusion laminated to the resulting cloth-like material to yield an EMI suppression sheet.

The polyamide film had a thickness of 50 μm.

### Example 3

A Fe—Si—Al alloy material as a metal powder was ground to a flat shape in a medium agitation mill using toluene as a solvent, and subsequently classified to remove large coarse particles to give a particle size (D50) of 35 μm. 150 Parts by weight of the thus-obtained flat Fe—Si—Al powder, 100 parts by weight of a carbon black powder as a conductive material, and 100 parts by weight of a polyurethane dissolved in 300 parts by weight of DMF, 30 parts by weight of toluene, and 170 parts by weight of MEK were mixed with stirring to give a solution of an EMI absorbing polymer resin composition.

The resulting solution of the EMI absorbing polymer resin composition was applied to a 12.5 μm thick polyimide (PI) film (Du Pont-Toray; “Kapton 50H”), i.e., a polymer resin layer (II), using a doctor blade, and dried at 140° C. for 3 minutes to give an EMI absorbing polymer resin layer (I) with a thickness of 50 μm, thereby yielding a two-layered EMI suppression film with a thickness of about 63 μm.

The resulting flat yarn was cut into a slit with a cutter to yield an EMI suppression flat yarn with a thickness of 63 μm and a width of 2 mm.

The resulting flat yarn was braided using a 8-carrier round braider to give an EMI suppression braid with an inner diameter of 5 mm.

The same polyamide composition as that of Example 1 was extrusion laminated to the resulting braid to yield an EMI suppression tube.

The resulting tube was capable of suitably covering a multicore cable with a finish outer diameter of 4.8 mm.

The polyamide film had a thickness of 50 μm.

### Example 4

A solution of an EMI absorbing polymer resin composition was obtained in the same manner as in Example 3, except that 50 parts by weight of a Fe₃Si powder similarly obtained by being ground to a flat shape and classified were used instead of 150 parts by weight of the Fe—Si—Al alloy powder used in Example 3.

The resulting solution of the EMI absorbing polymer resin composition was applied to a 25 μm thick polyphenylene sulfide (PPS) film (Toray; “Torelina 3030”), i.e., a polymer resin layer (II), using a doctor blade, and dried at 140° C. for 3 minutes, to give an EMI absorbing polymer resin layer (I) with a thickness of 50 μm, thereby giving a two-layered EMI suppression film with a thickness of about 75 μm.

The resulting film was cut into a slit with a cutter to yield an EMI suppression flat yarn with a thickness of 75 μm and a width of 0.6 mm.

The resulting EMI suppression flat yarn was braided into an braid using a 4-carrier round braider, after which end portions of the flat yarn were ultrasonically welded to give an EMI suppression tube with an inner diameter of 0.8 mm.

The resulting tube was capable of suitably covering a cable with a finish outer diameter of 0.61 mm.

### Example 5

An EMI suppression film manufactured in the same manner as in Example 1 was cut into a slit with a cutter to yield an EMI suppression flat yarn with a thickness of 63 μm and a width of 1 mm.

The resulting flat yarn was knitted in stockinette stitch using a knitter to give a cloth-like material.

The same polyamide composition as that of Example 1 was extrusion laminated to the resulting cloth-like material to yield an EMI suppression sheet.

The polyamide film had a thickness of 50 μm.

### Example 6

A high-density polyethylene (Japan Polyethylene; HY-433; density: 0.956, MFR: 0.55) was made into a film by inflation molding, and the resulting film was cut into a slit using a razor.

The film was subsequently drawn six times its original length on a hot plate at a temperature of 110 to 120° C., and subsequently subjected to a 10% relaxation heat treatment in a hot air circulating oven at 120° C., thus giving a drawn yarn with a yarn width of 0.85 mm and a fineness of 130 dtex.

The resulting drawn yarn was used as the warp, and the EMI suppression flat yarn with a thickness of 63 μm and a width of 3 mm manufactured in the same manner as in Example 1 was used as the weft; the warp and weft were woven in a plain weave with a yarn count of 35 by 8 yarns per 25.4 mm, using a Sulzer loom, thus yielding a cloth-like material.

The same polyamide composition as that of Example 1 was extrusion laminated to the resulting cloth-like material to yield an EMI suppression sheet.

The polyamide film had a thickness of 50 μm.

### Example 7

An EMI suppression film manufactured in the same manner as in Example 1 was cut into a slit with a cutter to yield an EMI suppression flat yarn with a thickness of 63 μm and a width of 5 mm.

The resulting flat yarn was spirally wound, after which end portions of the flat yarn were ultrasonically welded to yield an EMI suppression tube with an inner diameter of 1.2 mm. The resulting tube was capable of suitably covering a cable with a finish outer diameter of 1.13 mm.

### Example 8

An EMI suppression film manufactured in the same manner as in Example 1 was cut into a slit with a cutter to yield an EMI suppression flat yarn with a thickness of 63 μm and a width of 6 mm.

The resulting flat yarn was rolled into the form of rolled sushi, after which end portions of the flat yarn were adhered to each other with an adhesive, thus giving an EMI suppression tube with an inner diameter of 1.5 mm. The resulting tube was capable of suitably covering a cable with a finish outer diameter of 1.32 mm.

### Example 9

An EMI suppression film manufactured in the same manner as in Example 1 was cut into a slit with a cutter to yield an EMI suppression flat yarn with a thickness of 63 μm and a width of 70 mm.

The resulting flat yarn was rolled into the form of rolled sushi, and subsequently flattened, thereby yielding an envelope-like EMI suppression tube with a width of 31 mm. The resulting tube was capable of suitably covering a flat cable with a width of 30 mm.

### Example 10

A high-density polyethylene (Japan Polyethylene; HY-433; density: 0.956, MFR: 0.55) was made into a film by inflation molding, and the resulting film was cut into a slit using a razor. The film was subsequently drawn six times its original length on a hot plate at a temperature of 110 to 120° C., and subsequently subjected to a 10% relaxation heat treatment in a hot air circulating oven at 120° C., thus giving a polyethylene drawn flat yarn with a yarn width of 1.3 mm and a fineness of 310 dtex.

Further, an EMI suppression film manufactured in the same manner as in Example 1 was cut into a slit with a cutter to yield an EMI suppression flat yarn with a thickness of 63 μm and a width of 1.3 mm.

The polyethylene drawn flat yarn and EMI suppression flat yarn were alternately used as the warp, and the polyethylene drawn flat yarn was used as the weft; the warp and weft were woven in a plain weave with a yarn count of 17 by 17 yarns per 25.4 mm, using a Sulzer loom, thus yielding a cloth-like material.

The same polyamide resin composition as that of Example 1 was extrusion laminated to the resulting cloth-like material to yield an EMI suppression sheet. The polyamide film had a thickness of 50 μm.

### Comparative Example 1

70 Parts by weight of a Ni—Cu—Zn ferrite powder with an average particle size of 3 μm as a metal powder and 30 parts by weight of a carbon powder were mixed, after which the mixture was kneaded with 100 parts by weight of polyvinyl chloride with stirring, thus giving an EMI absorbing polymer resin composition.

The resulting composition was extrusion molded using an extruder to yield an EMI suppression material sheet with a thickness of 50 μm.

This sheet was cut into a slit with a cutter, thereby manufacturing an EMI suppression flat yarn.

### Comparative Example 2

7 Parts by weight of a Ni—Cu—Zn ferrite powder with an average particle size of 3 μm as a magnetic powder material and 3 parts by weight of a carbon powder were mixed, after which the mixture was kneaded with 90 parts by weight of polyvinyl chloride with stirring, thus giving an EMI absorbing polymer resin composition.

The resulting composition was extrusion molded using an extruder to yield an EMI suppression material sheet with a thickness of 50 μm.

This sheet was cut into a slit with a cutter, thereby manufacturing an EMI suppression flat yarn.

[Evaluation]

Flat yarn manufacturability: the extent to which the flat yarn can be continuously manufactured without developing defects such as pinholes, voids, and tears was evaluated according to the following criteria. The measurement results are shown in Table 2.
A: Capable of being continuously manufactured to a length of 500 m or more.
B: Capable of being continuously manufactured to a length of 50 m or more and less than 500 m.
C: Capable of being continuously manufactured to a length of less than 50 m.

Tensile strength: the tensile strength was measured according to the method defined in JIS L-1013, at a tensile rate of 300 mm/min and at 23° C. The measurement results are shown in Table 2.

Elongation: the elongation was measured according to the method defined in JIS L-1013, at a tensile rate of 300 mm/min and at 23° C. The measurement results are shown in Table 2.

Transmission loss (S21) and return loss (S11): the transmission loss (S21) and return loss (S11) were measured for the above-described EMI suppression films, using a transmission attenuation power ratio measurement system; Keycom (according to IEC62333-1 and IEC62333-2). The measurement results are shown in Table 2.

TABLE 2

| | Amount of EMI Absorbing Resin Layer (I) | | | | | | | Presence | | |
|---|---|---|---|---|---|---|---|---|---|---|
| | (Parts by Weight) | | | | | Polymer | Polymer | or Absence | Flat Yarn | |
| | Carbon | | | | | Resin Layer | Resin Layer | of Release | Manufactur- | |
| | Black | Metal Particles | | Resin | | (II) | (III) | Paper | ability | Shape |
| Ex. 1 | 100 | Fe₃O₄ | 300 | PU | 100 | PU | — | Present | A | Sheet |
| Ex. 2 | 100 | — | 0 | PU | 100 | PET | PU | Absent | A | Sheet |
| Ex. 3 | 100 | Fe—Si—Al | 150 | PU | 100 | PI | — | Absent | A | Tubular |
| Ex. 4 | 100 | Fe₃Si | 50 | PU | 100 | PPS | — | Absent | A | Tubular |
| Ex. 5 | 100 | Fe₃O₄ | 300 | PU | 100 | PU | — | Present | A | Sheet |
| Ex. 6 | 100 | Fe₃O₄ | 300 | PU | 100 | PU | — | Absent | A | Sheet |
| Ex. 7 | 100 | Fe₃O₄ | 300 | PU | 100 | PU | — | Present | A | Spirally Wound |
| Ex. 8 | 100 | Fe₃O₄ | 300 | PU | 100 | PU | — | Present | A | Rolled Sushi-Like |
| Ex. 9 | 100 | Fe₃O₄ | 300 | PU | 100 | PU | — | Present | A | Envelope-Like |
| Ex. 10 | 100 | Fe₃O₄ | 300 | PU | 100 | — | — | Absent | A | Sheet |
| Comp. Ex. 1 | 30 | Ni—Cu—Zn | 70 | PVC | 100 | — | — | — | C | Sheet |
| Comp. Ex. 2 | 3 | Ni—Cu—Zn | 7 | PVC | 90 | — | — | — | A | Sheet |

| | Tensile | | | | | | | | | |
|---|---|---|---|---|---|---|---|---|---|---|
| | Strength | Elongation | Transmission Loss (S₂₁)(dB) | | | | Return Loss (S₁₁)(dB) | | | |
| | [N/mm] | [%] | 0.477 GHz | 1.0 GHz | 1.56 GHz | 5.8 GHz | 0.477 GHz | 1.0 GHz | 1.56 GHz | 5.8 GHz |
| Ex. 1 | 0.02 | 100 | −1.4 | −3.2 | −6.9 | −18.5 | −9.3 | −12.1 | −8.6 | −8.0 |
| Ex. 2 | 3.5 | 85 | −1.5 | −3.7 | −7.1 | −14.5 | −8.9 | −10.4 | −8.8 | −7.5 |
| Ex. 3 | 2.8 | 80 | −1.6 | −3.8 | −7.9 | −21.0 | −8.9 | −11.5 | −8.4 | −7.3 |
| Ex. 4 | 2.5 | 75 | −1.6 | −3.7 | −7.9 | −17.5 | −9.1 | −11.4 | −8.4 | −7.3 |
| Ex. 5 | 0.02 | 100 | −1.4 | −3.2 | −6.9 | −18.5 | −9.3 | −12.1 | −8.6 | −8.0 |
| Ex. 6 | 0.02 | 100 | −1.4 | −3.2 | −6.9 | −18.5 | −9.3 | −12.1 | −8.6 | −8.0 |
| Ex. 7 | 0.02 | 100 | −1.4 | −3.2 | −6.9 | −18.5 | −9.3 | −12.1 | −8.6 | −8.0 |
| Ex. 8 | 0.02 | 100 | −1.4 | −3.2 | −6.9 | −18.5 | −9.3 | −12.1 | −8.6 | −8.0 |
| Ex. 9 | 0.02 | 100 | −1.4 | −3.2 | −6.9 | −18.5 | −9.3 | −12.1 | −8.6 | −8.0 |
| Ex. 10 | 0.02 | 100 | −1.4 | −3.2 | −6.9 | −18.5 | −9.3 | −12.1 | −8.6 | −8.0 |
| Comp. Ex. 1 | Could Not Be Molded | | Could Not Be Measured | | | | Could Not Be Measured | | | |
| Comp. Ex. 2 | 0.2 | 200 | −0.05 | −0.07 | −0.05 | −0.08 | −38.4 | −37.2 | −42.0 | −36.9 |

PU Polyurethane Resin
PVC Vinyl Chloride Resin
PET Polyethylene Terephthalate Resin
PI Polyimide Resin
PPS Polyphenylene Sulfide Resin

1. An electromagnetic interference suppression flat yarn comprising:
a first electromagnetic interference absorbing polymer resin layer (I) capable of absorbing electromagnetic interference, wherein a value of return loss (S11) as measured according to IEC-62333 is −1 dB or less over an entire range of electromagnetic interference frequencies of 300 MHz to 18 GHz, and a value of transmission loss (S21) as measured according to IEC-62333 is −1 dB or less over an entire range of electromagnetic interference frequencies of 300 MHz to 18 GHz; and a second polymer resin layer (II) on one surface of the first electromagnetic interference absorbing polymer resin layer (I).

2. The electromagnetic interference suppression flat yarn according to claim 11, wherein the first electromagnetic interference absorbing polymer resin layer (I) comprises a polyurethane resin; and a metal powder capable of absorbing electromagnetic interference or a carbon black powder.

3. The electromagnetic interference suppression flat yarn according to claim 2, wherein the second polymer resin layer (II) or third polymer resin layer (III) is at least one polymer resin layer selected from a polyester resin layer, a polyetherimide resin layer, a polyimide resin layer, a polyphenylene sulfide resin layer, and a polyurethane resin layer.

4. An electromagnetic interference suppression article formed into any of a fabric, tube, knit, or braid, using as a material the suppression flat yarn as defined in claims 3.

5. A method for manufacturing an electromagnetic interference suppression flat yarn, comprising:
mixing a polyurethane resin and a metal powder or a carbon black powder with stirring to prepare a solution of an electromagnetic interference absorbing polymer resin composition;
applying the solution of the electromagnetic interference absorbing polymer resin composition to a polymer resin layer (II), and drying the solution, to form an electromagnetic interference absorbing polymer resin layer (I), thereby manufacturing a two-layered electromagnetic interference suppression film; and
cutting the laminated film into a slit.

6. The method according to claim 5, wherein another polymer resin layer (III) is formed on a surface opposite the surface of the electromagnetic interference absorbing polymer resin layer (I) having the polymer resin layer (II) thereon, of the laminated film of the electromagnetic interference absorbing polymer resin layer (I) and polymer resin layer (II), thereby manufacturing a three-layered electromagnetic interference suppression film.

7. The method according to claim 6, wherein the polymer resin layer (II) or polymer resin layer (III) is at least one polymer resin layer selected from a polyester resin layer, a polyetherimide resin layer, a polyimide resin layer, a polyphenylene sulfide resin layer, and a polyurethane resin layer.

8. A method for manufacturing an electromagnetic interference suppression flat yarn, comprising:
mixing a polyurethane resin solution in which a polyurethane resin is dissolved in a solvent and a metal powder or a carbon black powder with stirring to prepare a solution of an EMI electromagnetic interference absorbing polymer resin composition;
applying the solution of the EMI electromagnetic interference absorbing polymer resin composition to a release paper, and drying the solution, to form an electromagnetic interference absorbing polymer resin layer (I);
forming a polymer resin layer (II) on the electromagnetic interference absorbing polymer resin layer (I);
peeling the release paper to manufacture a laminated film; and cutting the laminated film into a slit.

9. The method according to claim 8, wherein the polymer resin layer (II) is at least one resin layer selected from a polyester resin layer, a polyetherimide resin layer, a polyimide resin layer, a polyphenylene sulfide resin layer, and a polyurethane resin layer.

10. A method for manufacturing the electromagnetic interference suppression flat yarn as defined in claim 9, the flat yarn comprising:
an electromagnetic interference absorbing polymer resin layer (I) capable of absorbing electromagnetic interference, wherein a value of return loss (S11) as measured according to IEC-62333 is −1 dB or less over an entire range of EMI frequencies of 300 MHz to 18 GHz, and a value of transmission loss (S21) as measured according to IEC-62333 is −1 dB or less over an entire range of electromagnetic interference frequencies of 300 MHz to 18 GHz.

11. The electromagnetic interference suppression yarn according to claim 1 wherein the second polymer resin layer (II) is on one surface of the first electromagnetic interference absorbing polymer resin layer (I) and further comprises a third polymer resin layer (III) on another surface of the first electromagnetic radiation absorbing polymer resin layer (I).
